(19) United States
(12) Patent Application Publication
(10) Pub. No.: US 2009/0094702 A1
(43) Pub. Date: Apr. 9, 2009

(54) SECURE APPARATUS, INTEGRATED CIRCUIT, AND METHOD THEREOF

(75) Inventors: Ching-Chao Yang, Hsinchu City (TW); Tzung-Shian Yang, Yilan County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/867,039

(22) Filed: Oct. 4, 2007

(51) Int. Cl. G06F 21/00

(52) U.S. Cl. 726/34

(57) ABSTRACT

A wireless apparatus, an integrated circuit, and a method thereof. The wireless apparatus, providing hardware security, comprises a secure memory and a secure Integrated Circuit (IC). The secure memory comprises security authentication data. The secure IC, coupled to the secured memory, comprises a processor, a security controller, a security pin, and a read only memory (ROM). The processor is configured to process data. The security controller, coupled to the processor and the secure memory, translates the security authentication data to the processor. The security pin, coupled to the security controller, enables security of the secure IC. The ROM, coupled to the processor, has stored thereon instructions determining a security level according to the security authentication data and the security of the secure IC. The instructions are executed by the processor upon a boot-up operation.

### BACKGROUND OF THE INVENTION

1. Field of the Invention

The invention relates in general to hardware security, and in particular, to a secure apparatus, an integrated circuit, and a method of providing hardware security.

2. Description of the Related Art

Wireless communication systems need a security environment that delivers interoperability, portability and greater development speed while significantly lowering costs for advanced security applications. The wireless communication systems may be based on Code Division Multiple Access (CDMA), Time Division Multiple Access (TDMA), Frequency Division Multiple Access (FDMA), other modulations techniques, or combination thereof.

Piracy or fraud occurs in conventional communication systems when the data transmitted from a cellular telephone is intercepted and decoded to provide the cellular pirate with equipment serial number (ESN) or international mobile equipment identifier (IMEI) of the user. The pirated ESN or IMEI is then used in other cellular phones, resulting in losses for the pirated ESN or IMEI, and the data and service providers.

Hardware security schemes are implemented into the cellular phones by some manufacturers to protect against the IMEI and ESN frauds, typically by including a unique authentication code in the memory thereof. By performing checks on the authentication codes in the cellular phone, the data and service providers only allow cellular phones with the valid authentication codes to access data and services. Problems arise when the memory is erased to install new system software and reprogrammed to download the unique identification code.

Since not all phone manufactures require hardware security, integrated circuit (IC) manufactures manufacture ICs with the security feature activated by configuring one built-in time programmable (OTP) memory or eFuse prior to shipping to the customers, leading to problems in stock management, increased design cost and system configuration cost.

Thus a need exists for an IC with simple security configuration.

### BRIEF SUMMARY OF THE INVENTION

A detailed description is given in the following embodiments with reference to the accompanying drawings.

A secure apparatus capable of providing hardware security is disclosed, comprising a secure memory and a secure Integrated Circuit (IC). The secure memory comprises security authentication data. The secure IC, coupled to the secured memory, comprises a processor, a security controller, a security pin, and a read only memory (ROM). The processor is configured to process data. The security controller, coupled to the processor and the secure memory, translates the security authentication data to the processor. The security pin, coupled to the security controller, enables security of the secure IC. The ROM, coupled to the processor, has stored thereon instructions determining a security level according to the security authentication data and the security pin of the secure IC. The instructions are executed by the processor upon a boot-up operation.

According to another embodiment of the invention, an integrated circuit capable of providing hardware security is provided, comprising a processor, a security controller, a security pin, and a ROM. The processor is configured to process data. The security controller, coupled to the processor and a secure memory comprising security authentication data, transfers the security authentication data to the processor. The security pin, coupled to the security controller, enables security of the integrated circuit. The ROM, coupled to the processor, has stored thereon instructions determining a security level according to the security authentication data and the security of the integrated circuit. The instructions are executed by the processor upon a boot-up operation.

According to yet another embodiment of the invention, a method of providing hardware security comprises a secure IC downloading security authentication data from a secure memory, a security controller translating the security authentication data to a processor, a security pin enabling security of the secure IC, a read only memory (ROM) providing instructions determining a security level according to the security authentication data and the security of the secure IC, and the processor executing the instruction upon a boot-up operation.

### BRIEF DESCRIPTION OF THE DRAWINGS

The invention can be more fully understood by reading the subsequent detailed description and examples with references made to the accompanying drawings, wherein:

FIG. 1 is a block diagram of an exemplary secure communication system according to the invention.

FIG. 2 is a block diagram of a conventional secure apparatus.

FIG. 3 is a block diagram of an exemplary secure apparatus according to the invention.

FIG. 4 is a flowchart of an exemplary method providing hardware security according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

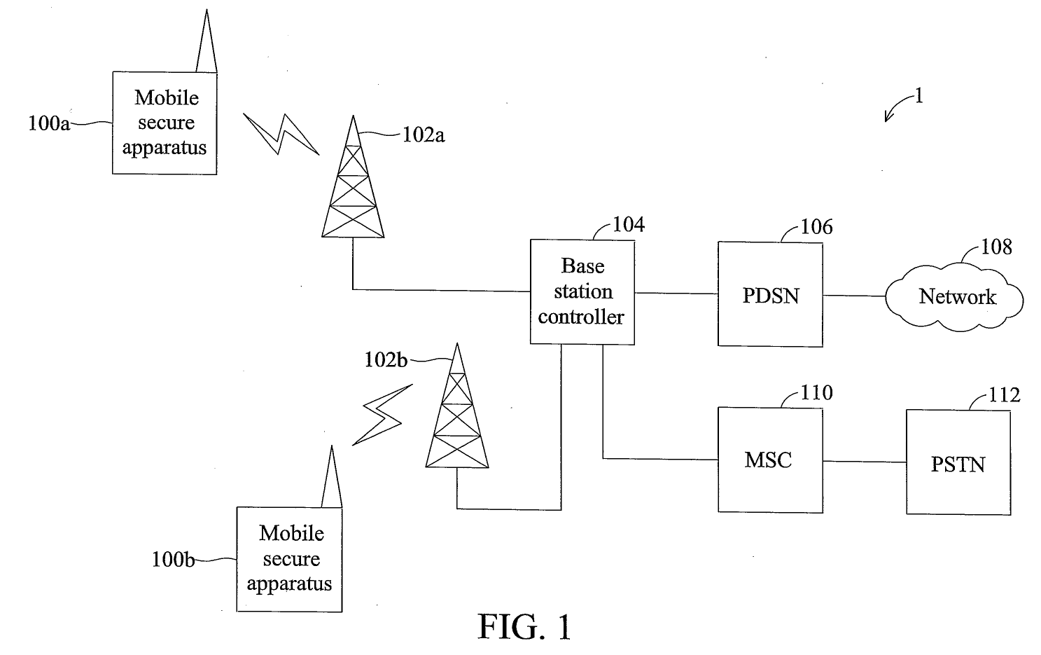

FIG. 1 is a block diagram of an exemplary secure communication system according to the invention, comprising mobile secure apparatuses 100a and 100b, base stations 102a and 102b, base station controller 104, packet data serving node (PDSN) 106, network 108, mobile switching center (MSC) 110, and switched telephone network (PSTN). Mobile secure apparatus 100a is coupled to base station 102a and Mobile secure apparatus 100b is coupled to base station 102b. Both base stations then subsequently coupled to base station controller (BSC) 104, PDSN 106 and MSC 110, and to network 108 and PSTN respectively.

In system 1, each mobile secure apparatus communicates with one or more base stations 102 over a wireless link at any particular moment, depending on whether the mobile secure apparatus is active or in soft handoff. BSC 104 provides coordination and control for each base station, and controls the routing of calls and data translation for each mobile secure apparatus.

For data services, BSC 104 couples to PDSN 140 performing various functions to support packet data service. Network 108 may be an Internet Protocol (IP) network such as the Internet. Each mobile apparatus can access data and/or service from servers over the Internet. For voice services, BSC 104 couples to MSC 110. MSC 110 controls the routing of telephone calls between mobile secure apparatus 100a. Each mobile secure apparatus can access conventional telephone service in PSTN 112 through MSC 110.

Mobile secure apparatus 100a is compliant with one or more CDMA standards such as the IS-95, IS-98, cdma2000, W-CDMA, or other CDMA standard, or a combination thereof. These CDMA standards are known in the art and incorporated herein by reference.

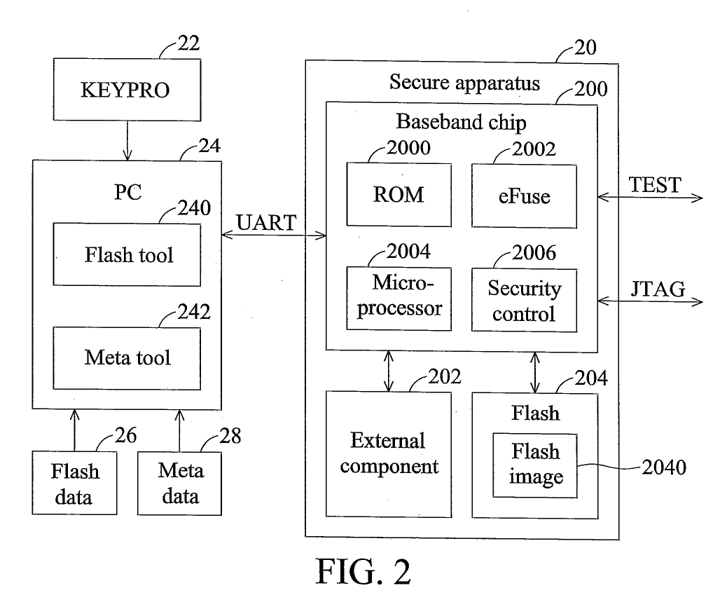

FIG. 2 is a block diagram of a conventional secure apparatus, comprising secure apparatus 20, KEYPRO 22, PC 24, flash data 26 and metadata 28. Secure apparatus 20 comprises baseband chip 200, external component 202, and flash memory 204. Baseband chip 200 comprises ROM (read only memory) 2000, eFuse 2002, microprocessor 2004, security control unit 2006. Baseband chip 200 communicates with external components through peripheral buses such as debug pin TEST, JTAG (Joint Test Action Group) bus, UART (Universal Asynchronous Receiver/Transmitter) bus, and EMI (External Memory Interface) bus.

Microprocessor 2004 processes data and instructions for baseband chip 200. ROM 2000 comprises boot instructions to be executed in microprocessor 2004. EFuse 2002 stores security setting of baseband chip 200, indicating whether hardware security is enabled. Security control unit 2006 accesses a security authentication data (Flash image) in Flash memory 204 through the EMI bus so that the microprocessor 2004 can perform hardware security check on the security authentication data.

Upon a boot-up operation, microprocessor 2004 reads the boot instructions from ROM 2000, executes the boot instructions to disconnect all peripheral buses debug pin TEST, JTAG bus, and UART bus, and access the security setting in eFuse 2002. If the hardware security is enabled, microprocessor 2004 access the security authentication data to perform security check thereon, if not, microprocessor 2004 does not read the security authentication data from flash 204 nor check security of secure apparatus 20. Microprocessor 2004 than reconnects all peripheral buses and carries on the secure instructions/operations if the security authentication data is valid, and the non-secure instructions/operations if the security authentication data is invalid, or if the hardware security is disabled.

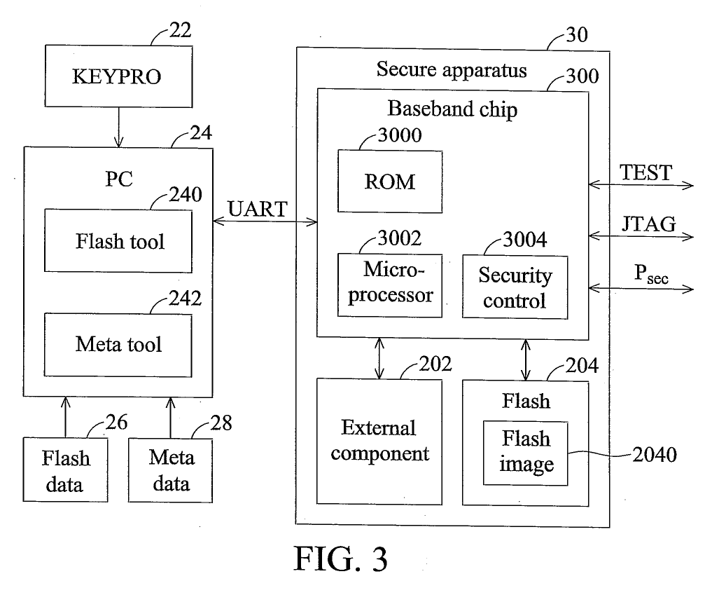

Since the value of eFuse 2002 is set during the manufacturing of ICs, use of eFuse 2002 for security setting of baseband chip 200 is not inflexible. A new secure apparatus is disclosed in FIG. 3 to replace the conventional design in FIG. 2.

FIG. 3 is a block diagram of an exemplary secure apparatus according to the invention, comprising secure apparatus 30, KEYPRO 22, PC 24, flash data 26 and metadata 28. Secure apparatus 30 comprises baseband chip 300, external component 202, and flash memory 204. Baseband chip 300 comprises ROM 3000, microprocessor 3002, security control unit 3004, and a security pin P_{sec}. Baseband chip 300 interfaces with external components through peripheral buses such as debug pin TEST, JTAG bus, UART bus, and EMI bus.

Secure apparatus 30 may be, but is not limited to, a mobile apparatus, such as a cellular phone, PDA, notebook computer, and alike. Flash (secure memory) 204 comprises flash image 2040 (security authentication data). Microprocessor 3002 is configured to process data and instructions. Microprocessor 3002 reads and executes the boot instructions upon a boot-up operation. Microprocessor 3002 may be implemented with a digital signal processor (DSP), an application specific integrated circuit (ASIC), a processor, a microprocessor, a controller, a microcontroller, a field programmable gate array (FPGA), a programmable logic device, other electronic unit, or any combination thereof designed to perform the functions described herein. Security control unit 3004 accesses flash image 2040 through EMI bus. Security pin P_{sec} provides security setting of baseband chip 300 by, for example, tying to ground to disable hardware security, or powering on to enable hardware security. ROM 3000 stores boot instructions determining a security level according to the security authentication data and the security setting. ROM 3000 and Flash 204 may be implemented with a Flash memory, a programmable ROM (PROM), an erasable PROM (EPROM), an electronically erasable PROM (EEPROM), a battery backed-up RAM, some other memory technologies, or a combination thereof.

(Joint Test Action Group (JTAG) standard, also known as IEEE 1149.1, is typically used for testing printed circuit boards using boundary scan. A universal asynchronous receiver/transmitter (UART) is an asynchronous transceiver, translating data between parallel and serial interfaces.) Microprocessor 3002 executes the boot instructions to disconnect all peripheral buses of baseband chip 300 prior to security check, to prevent hackers from accessing ROM 3000 and changing the codes therein.

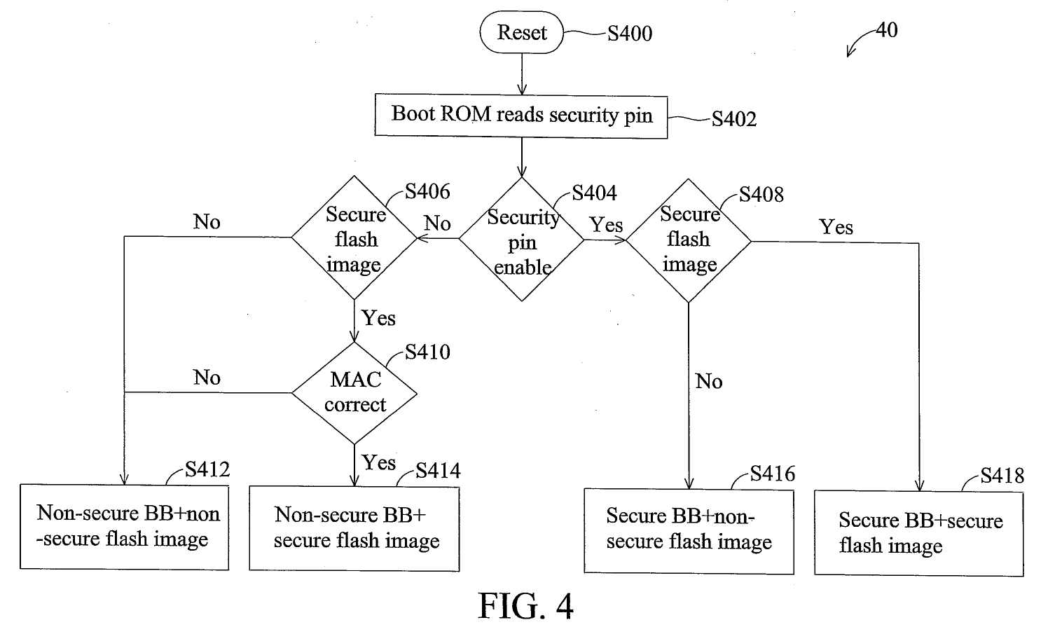

Since security settings can be changed by tying security pin P_{sec} to power on or ground off, the boot instructions in ROM 3000 require a new security procedure to provide the same security level as in FIG. 2. FIG. 4 shows a flowchart of an exemplary method providing hardware security according to the invention, incorporating the secure system in FIG. 2.

After secure apparatus 30 resets in step S400, microprocessor 3002 executes the boot instructions in ROM 3000 to read the security setting of security pin P_{sec} in step S402.

Processor 3002 then determines whether the security setting of the baseband chip 300 is enabled in step S404, carries on step S408 if so, and step S406 otherwise. Contrary to the boot instruction in the conventional secure apparatus in FIG. 2, processor 3002 continues to load flash image 2040 to perform security check, despite the security setting being a non-secure baseband chip.

In step S406, processor 3002 determines whether the flash image 2040 (security authentication data) is valid, and continues step S410 if so, and step S412 otherwise.

In step S410, processor 3002 further determines whether a message authentication code (MAC) in flash image 2040 is valid, and goes to step S414 if so or step S412 if not. A message authentication code (MAC), also referred to as Message Integrity Code (MIC), is encrypted information used to authenticate flash image 2040. A MAC algorithm accepts as input a secret key (in boot ROM 3000) and an arbitrary-length message (flash image 2040) to be authenticated, and outputs a MAC value. The MAC value protects both a message's integrity as well as its authenticity, by allowing verifiers (the secret key in boot ROM 3000) to detect any changes to the message content (flash image 2040).

In step S408, processor 3002 again determines whether the flash image 2040 (security authentication data) is valid, and continues step S418 if so, or step S416 if otherwise.

In step S412, processor 3002 determines apparatus 30 has a non-secure baseband chip 300 and non-secure flash image 2040, and then enables the peripheral bus including debug pin TEST, JTAG bus, UART bus, and EMI bus to permit non-secure data access.

In step S414, processor 3002 determines apparatus 30 has a non-secure baseband chip 300 and secure flash image 2040, enables the peripheral bus, including debug pin TEST, JTAG bus, UART bus, and EMI bus, to carry out secure data transaction, and forbids baseband chip 300 downloading flash image 2040. Because baseband chip 300 is non-secure, it might have been changed. Therefore, download of flash image 2040 is forbidden and no copy of secure flash image can be obtained.

In step S416, processor 3002 determines apparatus 30 has a secure baseband chip 300 and non-secure flash image 2040, leaves all peripheral buses disconnected, and allows baseband chip 300 to download flash image 2040. Since flash image 2040 is non-secure, flash 204 may have been changed. In this situation, all peripheral buses remain disconnected to prevent the instruction codes in ROM 3000 from being replaced.

In step S418, processor 3002 determines apparatus 30 has a secure baseband chip 300 and secure flash image 2040, and allows baseband chip 300 downloading flash image 2040. Processor 3002 checks MAC in flash image 2040, permits secure data transmission if the MAC is valid, and also allows downloading flash image if the MAC is invalid.

The disclosure reveals a secure apparatus and a method thereof setting a security level by a security pin of the secure apparatus, thereby reducing cost and complexity of the security configuration. The secure apparatus includes a boot ROM providing corresponding security levels and procedures according to the security pin and the flash image in the external flash. The security pin offers flexibility of the security configuration, and the boot ROM provides the security procedures preserving degree of security that is identical to the prior art, together the secure apparatus and the method thereof provide flexible security configuration without losing the degree of security level.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A secure apparatus capable of providing hardware security, comprising:
a secure memory comprising security authentication data; and
a secure Integrated Circuit (IC) coupled to the secured memory, comprising:
a processor configured to process data;
a security controller, coupled to the processor and the secure memory, translating the security authentication data to the processor;
a security pin, coupled to the security controller, enabling security of the secure IC; and
a read only memory (ROM), coupled to the processor, having stored thereon instructions determining a security level according to the security authentication data and the security of the secure IC, the instructions being executed by the processor upon a boot-up operation.

2. The wireless apparatus of claim 1, wherein the secure IC further comprises a peripheral bus disabled upon the boot-up process, and the instructions, when executed by the processor, causes the processor to perform:
determining whether the security of the secure IC is disabled;
determining whether the security authentication data is valid; determining whether a message authentication code (MAC) in the security authentication data is valid, if the security of the secured IC is disabled, and the security authentication data is valid; and
enabling the peripheral bus, if the MAC is valid.

3. The wireless apparatus of claim 2, wherein the instructions, when executed by the processor, causes the processor to further perform:
enabling the peripheral bus, if the MAC is invalid; and
forbidding the secure IC to download the security authentication data, if the MAC is invalid.

4. The wireless apparatus of claim 2, wherein the instructions, when executed by the processor, cause the processor to further perform:
allowing secure IC download of the security authentication data, if the security of the secured IC is enabled, and the security authentication data is invalid.

5. The wireless apparatus of claim 2, wherein the instructions, when executed by the processor, cause the processor to further perform:
allowing the secure IC to download the security authentication data, if the security of the secured IC is enabled, the security authentication data is invalid, and the MAC is invalid.

6. The wireless apparatus of claim 2, wherein the peripheral bus is Joint Test Action Group (JTAG) bus.

7. An integrated circuit capable of providing hardware security, comprising:
a processor configured to process data;
a security controller, coupled to the processor and a secure memory comprising security authentication data, translating the security authentication data to the processor;
a security pin, coupled to the security controller, enabling security of the integrated circuit; and
a read only memory (ROM), coupled to the processor, having stored thereon instructions determining a security level according to the security authentication data and the security of the integrated circuit, the instructions being executed by the processor upon a boot-up operation.

8. The integrated circuit of claim 7, further comprising a peripheral bus disabled upon the boot-up process; and wherein the instructions, when executed by the processor, causes the processor to perform:
determining whether the security of the secure IC is disabled;
determining whether the security authentication data is valid;
determining whether a message authentication code (MAC) in the security authentication data is valid, if the security of the secured IC is disabled, and the security authentication data is valid; and
enabling the peripheral bus, if the MAC is valid.

9. The integrated circuit of claim 8, wherein the instructions, when executed by the processor, causes the processor to further perform:
enabling the peripheral bus, if the MAC is invalid; and
forbidding the secure IC to download the security authentication data, if the MAC is invalid.

10. The integrated circuit of claim 8, wherein the instructions, when executed by the processor, causes the processor to further perform:maui) allowing the secure IC to download the security authentication data, if the security of the secured IC is enabled, and the security authentication data is invalid.

11. The integrated circuit of claim 8, wherein the instructions, when executed by the processor, causes the processor to further perform:
allowing the secure IC to download the security authentication data, if the security of the secured IC is enabled, the security authentication data is invalid, and the MAC is invalid.

12. The integrated circuit of claim 8, wherein the peripheral bus is Joint Test Action Group (JTAG) bus.

13. A method of providing hardware security, comprising:
a secure IC downloading security authentication data from a secure memory;
a security controller translating the security authentication data to a processor;
a security pin enabling security of the secure IC;
a read only memory (ROM) providing instructions determining a security level according to the security authentication data and the security of the secure IC; and
the processor executing the instruction upon a boot-up operation.

14. The method of claim 13, wherein the secure IC further comprises a peripheral bus disabled upon the boot-up process, and wherein execution comprises:
the processor determining whether the security of the secure IC is disabled;
the processor determining whether the security authentication data is valid;
the processor determining whether a message authentication code (MAC) in the security authentication data is valid, if the security of the secured IC is disabled, and the security authentication data is valid; and
the processor enabling the peripheral bus, if the MAC is valid.

15. The method of claim 14, wherein the execution step further comprises:
the processor enabling the peripheral bus, if the MAC is invalid; and
the processor forbidding the secure IC to download the security authentication data, if the MAC is invalid.

16. The method of claim 14, wherein the execution step further comprises:
the processor allowing the secure IC to download the security authentication data, if the security of the secured IC is enabled, and the security authentication data is invalid.

17. The method of claim 14, wherein the execution step further comprises:
the processor allowing the secure IC to download the security authentication data, if the security of the secured IC is enabled, the security authentication data is invalid, and the MAC is invalid.

18. The method of claim 14, wherein the peripheral bus is Joint Test Action Group (JTAG) bus.
